(19) United States
(12) Patent Application Publication
(10) Pub. No.: US 2003/0195859 A1
(43) Pub. Date: Oct. 16, 2003

(54) System and methods for authenticating and monitoring transactions

(76) Inventor: Jason E. Lawrence, Highlands Ranch, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/124,117

(22) Filed: Apr. 16, 2002

(51) Int. Cl. G06F 17/60

(52) U.S. Cl. 705/75

(57) ABSTRACT

Systems and methods for evaluating transactions. Various of the methods include providing a central control and receiving identification information associated with a user at the central control. In some cases, the identification information includes user contact information. In addition, a transaction request is received from a third party and matched to the user, and the user is alerted of the transaction request. Various systems include an interactive monitoring system that includes a central control coupled to a communication network. The central control includes a memory and a processor. Further, the memory includes instructions executable by the processor to receive contact information and account information related to a user, receive a transaction request including the account information from a third party, match the transaction request to the user, access the contact information associated with the user, and alert the user of the transaction request according to the contact information.

### BACKGROUND OF THE INVENTION

The present invention relates generally to authentication and monitoring of various transactions. In particular, the present invention provides systems and methods for authenticating a variety of transactions including, but not limited to, financial and/or personal information transactions. Further, the present invention provides systems and methods for monitoring such transactions and alerting an entity associated with the transactions of any ongoing activity.

Companies providing financial services sustain significant losses each year due to fraud. Such fraud can be in the form of a stolen credit card being used to purchase goods or services. In most cases, the credit card company is liable for the losses. For this reason, such companies have implemented a number of security measures aimed at reducing the incidence of fraud. For example, some companies offer a credit card that includes the card holder's photograph. This photograph can be used to assure that a person purchasing goods is authorized to use the credit card. Similarly, other measures include requiring a merchant to verify the person by viewing a driver's license or other photo identification.

While these approaches are somewhat effective, they are also cumbersome. Because of this, merchants often do not spend the time required to properly verify the person is authorized to use a particular card. Furthermore, such an approach limits the ability for a card holder to authorize another person to use their card. Thus, a child of the card holder cannot use a credit card provided to them by their parent. Yet further, such an approach does not provide any security in effectuating remote transactions, such as, those transactions completed using the Internet.

Beyond the losses sustained by companies providing financial services, individuals are often damaged through theft and misuse of the individual's identity. Such identity theft can include the misappropriation of a person's credit card numbers, account numbers, social security number, and other such personal information. A thief can then use this misappropriated information to incur obligations that will be borne by the individual designated by the misappropriated identity. It is often only after the bills begin to arrive that the individual even knows of the damage incurred. Likely, the individual's only recourse is to begin the process of canceling credit cards, changing social security numbers, closing bank accounts, and disclaiming obligations incurred by the thief. Such a process can be arduous and time consuming.

Therefore, there is a need in the art for solutions to authenticate and/or monitor ongoing transactions. Hence, among a number of other advantages apparent from the following description, the present invention provides systems and methods for addressing such problems.

### BRIEF SUMMARY OF THE INVENTION

Among other things, various aspects of the present invention relate to monitoring, authorizing, and/or limiting transactions associated with a given user. In one aspect of the present invention, a user can enter identification information including account information and contact information. The account information can be monitored to determine if any activity in association with the account is detected. When such activity is detected, the user can be apprised of the activity. Further, in some cases, the user can be asked to authenticate the activity. Where the user fails to authenticate the activity, the activity may be terminated or or otherwise denied. Yet further, the user can be apprised of suspicious activity, thus, allowing the user to take, among other things, prophylactic action to avoid any potential damage from the suspicious activity.

As just one example, a user may use a cell phone and a personal computer to provide information and receive account activity related to the user. More particularly, the user can enter the account to be monitored, as well as, the number for the cell phone into the personal computer, and transfer the information to a central control. Activity related to the account is then monitored by the central control. When activity is detected, the central control contacts the user via the cell phone.

Thus, for example, where the account is a credit card account, a user can be notified by the cell phone that the credit card is being used to effectuate a transaction. Further, the user can be requested to authorize the transaction by pressing a key or entering some other code via the cell phone. If the user authorizes the transaction, the central control provides an authorization and the transaction is consummated. Otherwise, the transaction can be denied.

Some embodiments of the present invention include methods for evaluating transactions associated with one or more transaction systems. Such methods include providing a central control and receiving identification information associated with a user at the central control. The identification information can include contact information related to the user. In addition, a transaction request is received from a third party, the request is matched to the user, and the user is alerted of the transaction request.

In some instances, the identification information further includes account information associated with the user. The transaction request also includes the account information, and comparison of the account information can be used to identify a user associated with the transaction request. Some instances also include receiving one or more notification parameters that at least in part controls notification of the user of a transaction request. Such notification parameters can include, but are not limited to, transaction limits.

In various instances, the account information received from either or both the third party or the user by the central control can be abstracted such that the information is matchable to a user, but also conceals the underlying account information. Such an approach can limit access to a user's account information and avoid potential fraudulent activities resulting from the disclosure of the information.

In some cases, a user can be notified of a potential identity theft. Further, a request from the user can be received by the central control, and the central control can act to limit the potential identity theft. Such limiting can include, but is not limited to, placing a hold on accounts related to the potential identity theft by the central control.

In various cases, alerting the user of the transaction request includes providing an acceptance request to the user. The method can further include receiving a response to the acceptance request, and providing an authorization to the third party based on the response to the acceptance request.

Other embodiments of the present invention include an interactive monitoring system. Such a monitoring system includes a central control coupled to a communication network. The central control includes a memory and a processor. Further, the memory includes instructions executable by the processor to receive contact information and account information related to a user, receive a transaction request including the account information from a third party, match the transaction request to the user, access the contact information associated with the user, and alert the user of the transaction request according to the contact information.

In some instances, the memory further includes instructions executable by the processor to receive at least one notification parameter associated from the user, and to access the notification parameter. Such alerting the user is based at least in part on the notification parameter. In some cases, the notification parameter includes a transaction limit and the instructions to alert the user of the transaction request include instructions to alert the user where the transaction request exceeds the transaction limit.

Yet other embodiments include a method for authenticating a user in a financial transaction. The method includes receiving identification information associated with a user at a central control. The identification information includes contact information and account information related to the user. The method further includes receiving a transaction request including the account information from a third party. The transaction request is matched to the user and an acceptance request is provided to the user. A response to the acceptance request is received and, based in part on the response, an authorization is provided to the third party.

Another embodiment includes a method for detecting potential identity theft. The method includes receiving at least contact information and a social security identification number related to a user at a central control, receiving a transaction request including the social security number from a third party, matching the transaction request to the user, and alerting the user of a potential identity theft.

These and other aspects are more fully developed in the detailed description below. Thus, the summary provides only a general outline of the embodiments according to the present invention. Many other objects, features and advantages of the present invention will become more fully apparent from the following detailed description, the appended claims and the accompanying drawings. dr

### BRIEF DESCRIPTION OF THE DRAWINGS

A further understanding of the nature and advantages of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is a schematic diagram including a transaction monitoring and/or authorization system in accordance with embodiments of the present invention;

FIG. 2 is a schematic diagram including another transaction monitoring and/or authorization system in accordance with other embodiments of the present invention;

FIG. 3 is a flow diagram illustrating a method of providing account, contact and parameter information in accordance with an embodiment of the present invention;

FIG. 4 is a user interface for facilitating the transfer of account information from a user to the central system as illustrated in FIG. 3;

FIG. 5 is a user interface requesting that a user set notification parameters as illustrated in FIG. 3;

FIGS. 6A-6C are user interfaces for facilitating the transfer of notification parameters and contact information as illustrated in FIG. 3;

FIG. 7 is a flow diagram illustrating a method of authorizing transactions in accordance with embodiments of the present invention;

FIG. 8 is an example of a transaction account presented on a POS device;

FIG. 9 is an example of a request to provide payment information via the POS device of FIG. 8;

FIG. 10 is an example of a authorization progress presented via the POS device of FIG.

FIG. 11 is an example of a denial provided via a POS device in accordance with various embodiments of the invention;

FIG. 12 is an example of a transaction alert provided to a user in accordance with some embodiments of the invention;

FIG. 13 is an example of an acceptance provided via a POS device in accordance with various embodiments of the invention;

FIGS. 14A-14D are examples of personal databank view screens in accordance with embodiments of the present invention;

FIG. 15 is a flow diagram illustrating a method of providing account, contact and parameter information including account information abstraction in accordance with an embodiment of the present invention;

FIG. 16 is a flow diagram illustrating a method of authorizing transactions including account information abstraction in accordance with the present invention;

FIG. 17 is a schematic diagram including an identity theft monitoring and/or curing system in accordance with embodiments of the present invention;

FIG. 18 is a flow diagram illustrating a method of providing monitoring information in accordance with an embodiment of the present invention; and

FIG. 19 is a flow diagram illustrating a method of monitoring and curing identity theft in accordance with the present invention.

### DETAILED DESCRIPTION OF THE INVENTION

The present invention provides systems and methods for monitoring, reporting, and/or authorizing transaction requests. Further, in some aspects, the present invention provides for monitoring and reporting the status of the transaction requests. In various aspects, the present invention provides an efficient and effective mechanism for responding to dubious transactions and/or implementing prophylactic measures to avoid the possibility of unwanted behavior, such as, identity theft.

As used herein, a transaction request can be any request to access or provide information related to a user, deposit or withdrawal funds from an account associated with a user, incur obligations on behalf of user, or the like. Thus, for example, a transaction request can include a request to use a credit card or a check to purchase goods or services. Alternatively, a transaction request can be a request to open a bank or brokerage account, a request for a credit report, a posting of positive or negative information on a credit report, filing an insurance claim, cashing a check, requesting medical records, an application for social security benefits, an application for a driver's license, an application for a passport or visa, an application for a credit card, or the like. In light of this document, one of ordinary skill in the art will recognize a number of other examples of transaction requests that can be monitored and/or authorized in accordance with the present invention.

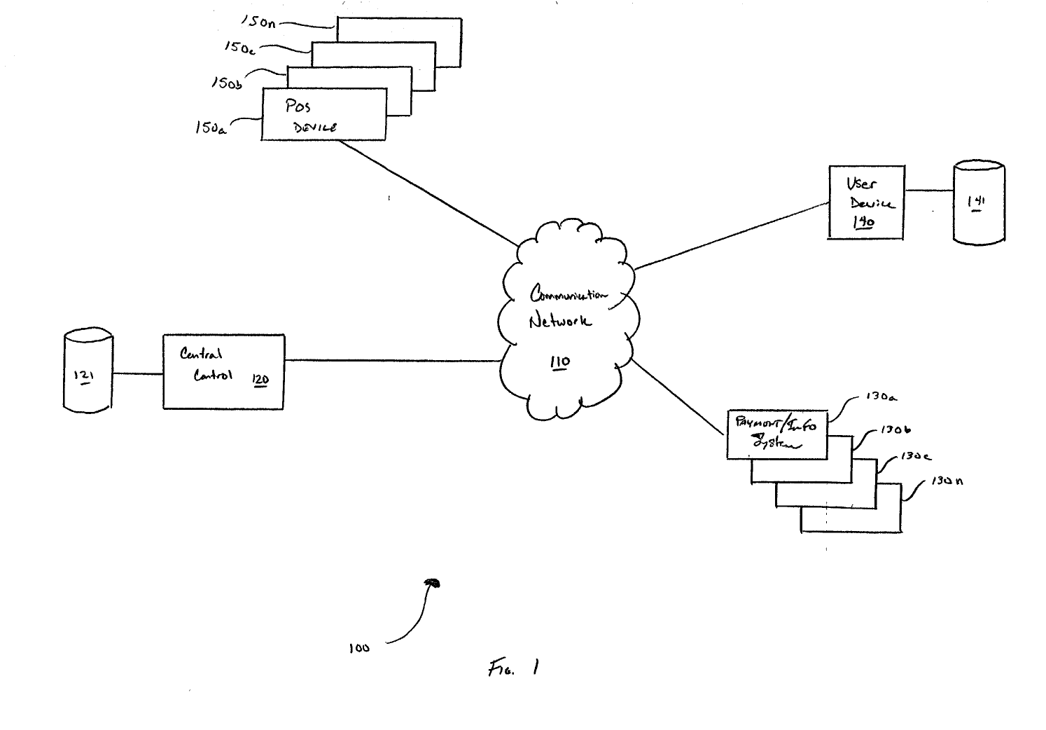

Referring to FIG. 1, a transaction monitoring and/or authorization system 100 is illustrated in accordance with embodiments of the present invention. As illustrated, transaction system 100 includes one or more point-of-sale (“POS”) devices 150, one or more user devices 140, one or more payment/information systems 130, and a central control 120 each communicably coupled to a communication network 110. A number of databases can be accessible from one or more of the devices associated with communication system 100. For description purposes, a database 121 is illustrated in relation to central control 120 and another database 141 is illustrated in relation to user device 140.

Communication network 110 can be any network capable of transmitting and receiving information. For example, communication network 110 can comprise a TCP/IP compliant virtual private network (“VPN”), the Internet, a local area network (“LAN”), a wide area network (“WAN”), a telephone network, a cellular telephone network, an optical network, a wireless network, or any other similar communication network.

In some embodiments, communication network 110 is a combination of a variety of network types. For example, in one embodiment, communication network comprises the Internet and/or a cellular telephone network for communicating between user device 140 and central control 120, a custom dial-up network for communicating between POS device 150 and payment/information system 130, and a Virtual Private Network (“VPN”) for communicating between central control 120 and payment/information system 130. In light of this document, one of ordinary skill in the art will recognize a number of other network types and/or combinations thereof that are capable of facilitating the various communications associated with the present invention.

POS device 150 can be any device for receiving and facilitating transaction requests. Thus, for example, POS device 150 can be a credit card reader, a smart cash register, a smart card reader, an automatic teller machine (“ATM”), a microprocessor based terminal at a merchant, a microprocessor based terminal associated with a vending machine or gas pump, a computer used to retrieve or update information, or any other such device.

User device 140 can be any device or combination of devices used to access and/or provide information associated with the user to system 100. For example, user device 140 can be a PC, a cellular telephone, a pager, a personal digital assistant (“PDA”), or the like. Further, user device 140 can be a composite device, such as, a PDA integrated with a cellular telephone. In some embodiments, user device 140 is Internet enabled and communicates via a wired and/or wireless interface. In one particular embodiment, user device 140 includes both a cellular telephone and a PC. Such a configuration is useful where the PC is accessed to upload information from user device 140 to central control 120, and the cellular telephone is used to receive authorization requests or other real time notifications from central control 120. Based on the discussion provided herein, one of ordinary skill in the art will recognize other devices and combinations of devices that can be used to perform the functions of user device 140.

In some embodiments, user device 140 is identified with the user. Thus, for example, the device can be a cellular telephone that the user has access to and from which a response can reasonably be presumed to emanate from the user or one authorized by the user. Such a device can be identified to central control 110, and central control 110 can then communicate via the device under the assumption that responses received therefrom are from the user.

Central control 120 can be any microprocessor based device capable of receiving transaction requests, and performing actions in relation to the transaction requests. Thus, for example, central control 120 can be a PC, a network server, a server supporting an Internet website, or the like. As will be more fully discussed below, central control 120 is used to provide acceptance and denial information from a user in various embodiments. In yet further embodiments, central control 120 is responsible for monitoring transaction request activity and alerting the user of such activity. Other uses and functions of central control 120 are discussed in detail below. One of ordinary skill in the art will recognize a number of other devices that can be used in accordance with the present invention to perform the functions described herein.

Databases 121, 141 can be any type of storage device associated with central control 120 or user device 140, respectively. Thus, for example, databases 121, 141 can be a hard drive, a floppy disk, a CD-ROM, a server database, or the like.

Payment/information system 130 can be any transaction system servicing one or more types of transaction requests. Thus, for example, payment/information system 130 can be a credit card processing system, a check processing system, a bank, a credit reporting system, a driver's license system, a stock trading system, an insurance benefit system, or the like.

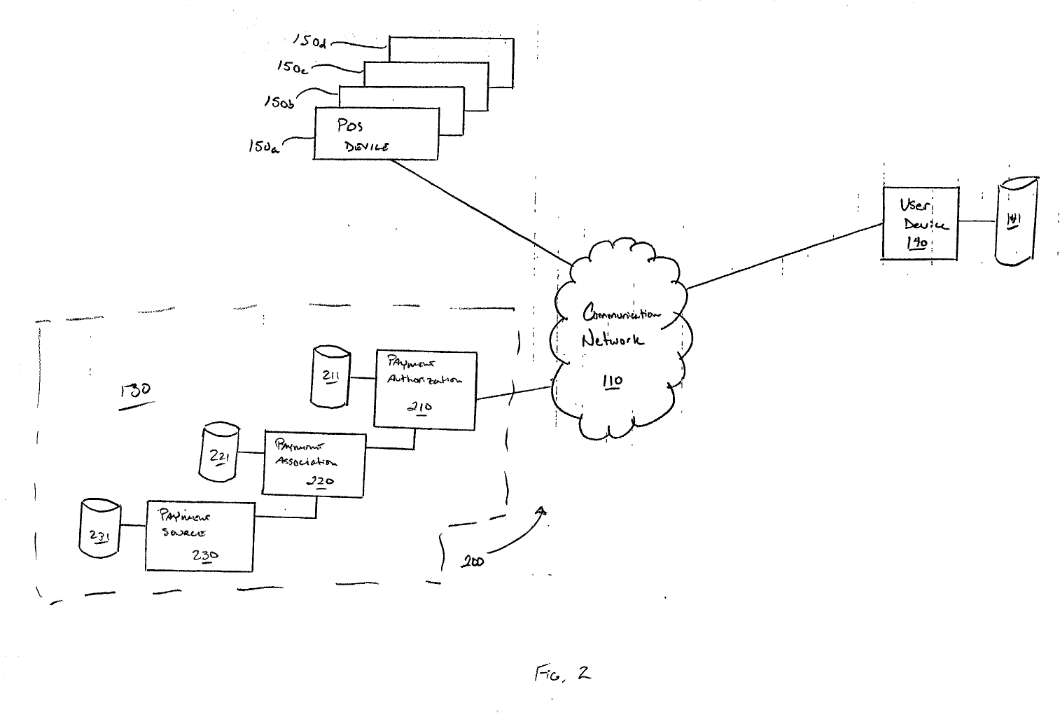

Referring to FIG. 2, another transaction monitoring and/or authorization system 200 is illustrated in accordance with various embodiments of the present invention. Payment/information system 130 of FIG. 1 is illustrated as a credit card processing system. Such a credit card processing system includes a payment authorization system 210, a payment association system 220, and a payment source system 220. Each of payment authorization device 210, payment association device 220, and payment source 220 are associated with databases 211, 221, and 231, respectively. In operation, a credit card transaction request received via POS device 150 is transmitted to payment authorization system 210 where an access to database 211 determines if the transaction can be authorized. If the transaction request is known to payment authorization system 210, then the transaction is either approved or denied based on parameters set by the credit card company. For example, if the card was reported stolen, or is over its limit, the credit card company may deny the transaction.

Such payment authorization systems 210 are not cognizant of all credit cards, therefore, a transaction request cannot be either accepted or denied. Where the transaction request is not known to payment authorization system 210, the transaction request can be transmitted to payment association system 220. Payment association system 220 is cognizant of many more credit cards. Where payment association system 220 is cognizant of the card, the transaction request can be either approved or denied as before. Where payment association system 220 is not cognizant of the card, the transaction request can be transmitted to payment source system 230 associated with the bank issuing the card. Here, a transaction request associated with the previously unknown card will ultimately be either denied or approved. Thus, payment/information source 130 is responsible for approving credit card transaction requests based on parameters set by the credit card company.

In various embodiments of the present invention, central control 120 (not shown) is also responsible for approving such transaction requests based on parameters provided by a user. In some embodiments, such as system 200, central control 120 (not shown) is not included as a separate devices or systems. Rather, the functions associated with central control 120 are distributed across POS device 150, user device 140 and/or payment/information system 130. Thus, for example, payment/information system 130 can provide authorization of a credit card based on parameters set be the issuing card company, and can also provide authorization based on parameters set by a user associated with the credit card. Based of the following discussion, one of ordinary skill in the art will recognize a number of ways for distributing the functionality of central control 120.

As such, providing a central control can include providing a central control as a system operated apart from any other element of systems 100, 200. Alternatively, providing a central control can include integrating the central control with one or more of the other elements of systems 100, 200. For convenience, the following discussion refers to central control as if it is a separate system. Providing such a separate system can have the advantage of, among other things, being independent, and thus responsive to a number of different entities. Alternatively, various advantages are associated with integrating central control 120 with one or more elements. As just one example, this can result in both time and cost efficiencies including, but not limited to, access to a user's account information already being available on payment/information system 130.

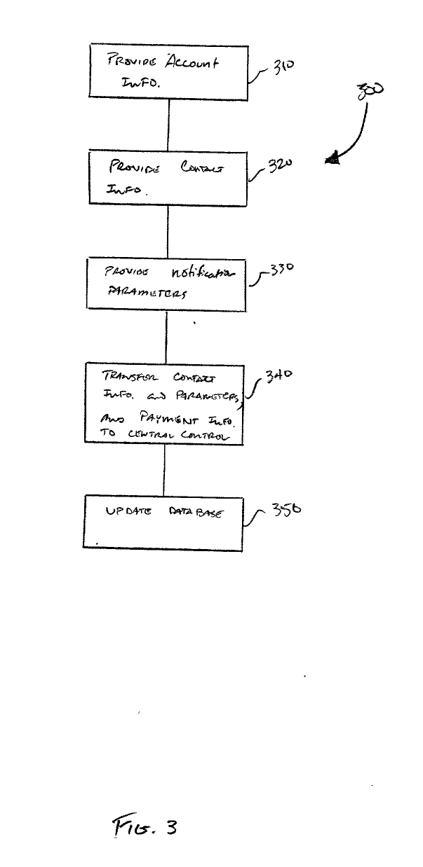

Various methods in accordance with the present invention for using systems 100, 200 are discussed in relation to FIGS. 3 through 19. Referring to FIG. 3, a flow diagram 300 illustrates a method of providing account, contact, and other identification information, along with notification parameters from user device 140 to central control 120. Account information is provided by a user to central control 120 (block 310). Such account information can identify one or more accounts that a user would like monitored. Thus, as examples, account information can include a bank account number, a credit card account number, a social security number, a driver's license number, an insurance number, a mortgage or other loan number, a utility provider account number, or the like.

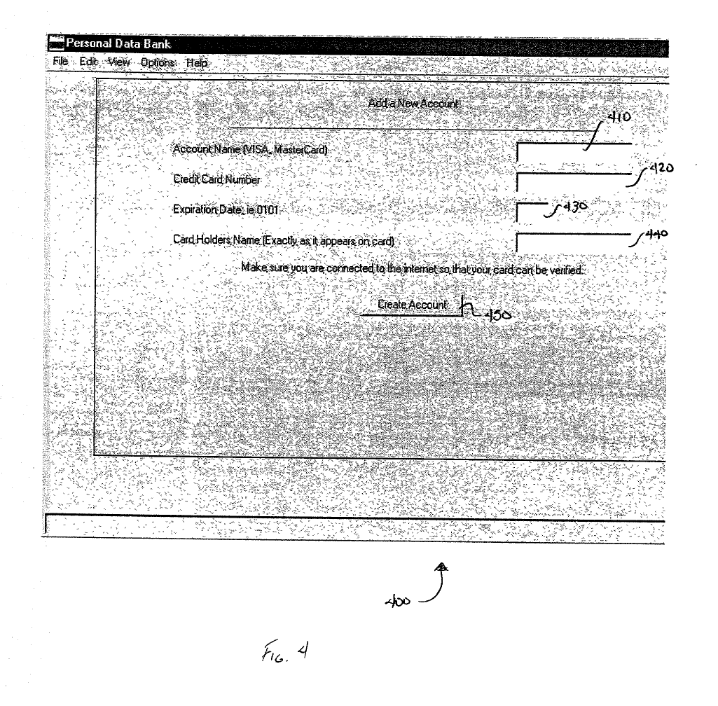

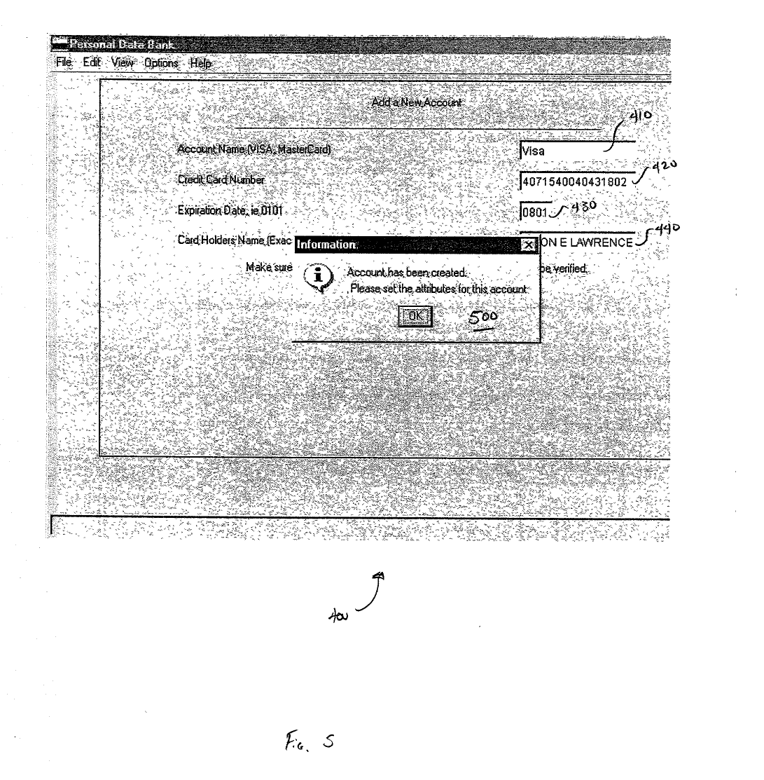

Such account information can be entered via a user interface operating on user device 140. An example of such an interface 400 tailored for operation on a PC is provided as FIG. 4. Interface 400 includes an entry field 410 for entering the name by which a user will identify the account, an entry field 420 for entering the account number, and entry field 430 for entering an expiration date in the case of a credit card or even an insurance policy, and an entry field 440 for entering the name associated with the account. Once each of the entry fields are populated, a user can click a create account selection 450 causing the entered information to be stored locally on database 141. In addition, the information is transferred to central control 120 across communication network 110, and stored in database 121 (blocks 340, 350). As illustrated in FIG. 5, a status box 500 is provided over user interface 400 to indicate the process is complete.

In one particular embodiment, user interface 400 is accessed via the Internet and user device 140 includes a PC. However, as previously discussed, user device 140 can be any number of device types and user interface 400 can be tailored to work on a variety of device types serving as user devices 140.

Referring again to FIG. 3, contact information is provided by the user via user device 140 to central control 120 (block 320). Such contact information designates the method by which the user is contacted by central control 120 when they are to be alerted of activity related to them. Contact information can include an email address, a telephone number, an Internet messenger number, a physical address, or the like. In addition, the contact information can be specific to a particular account or group of accounts. Thus, for example, a user may desire to be contacted by regular mail service when negative information is posted on their credit report, by cell phone when a credit card transaction at a retail location is incurred, and by email when a credit card transaction is effectuated across the Internet. In such a case, the contact information would include an email address, a cell phone number, and a physical address associated with the respective accounts.

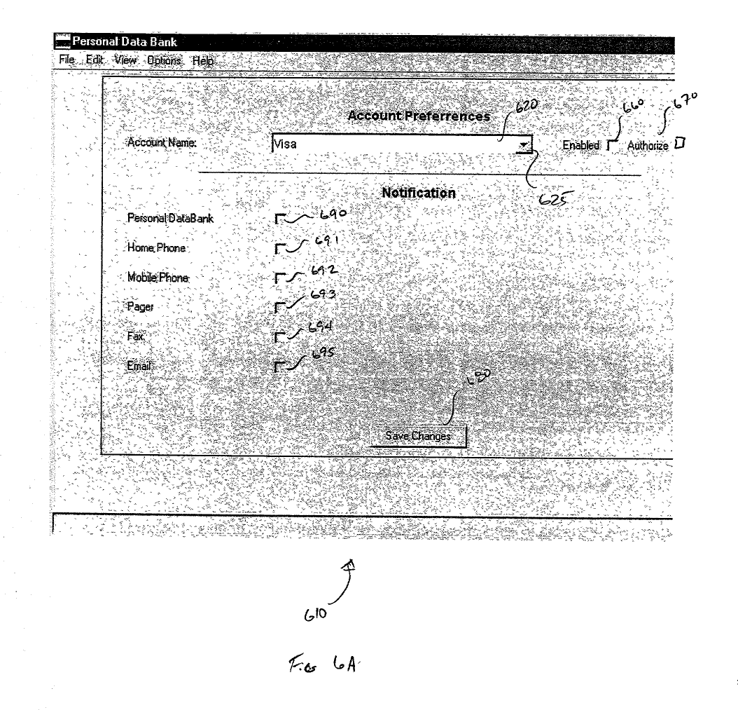

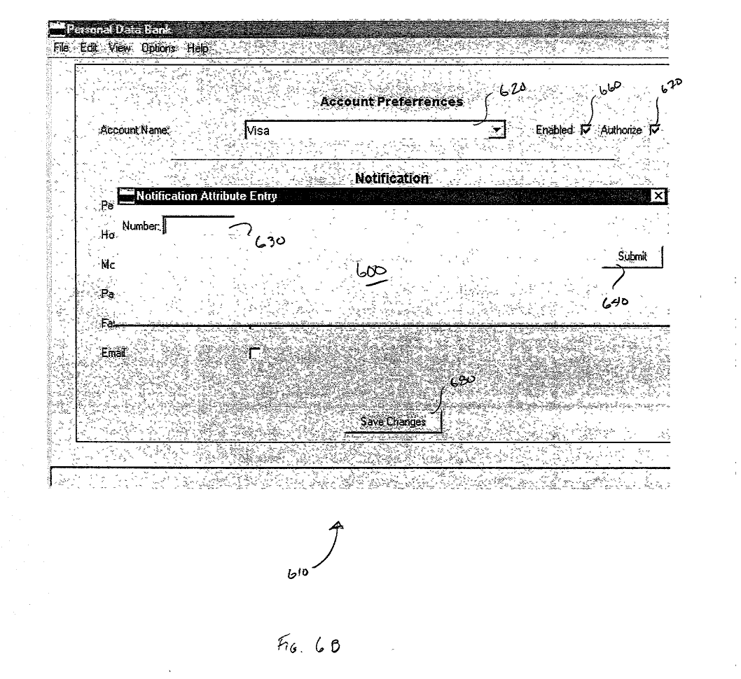

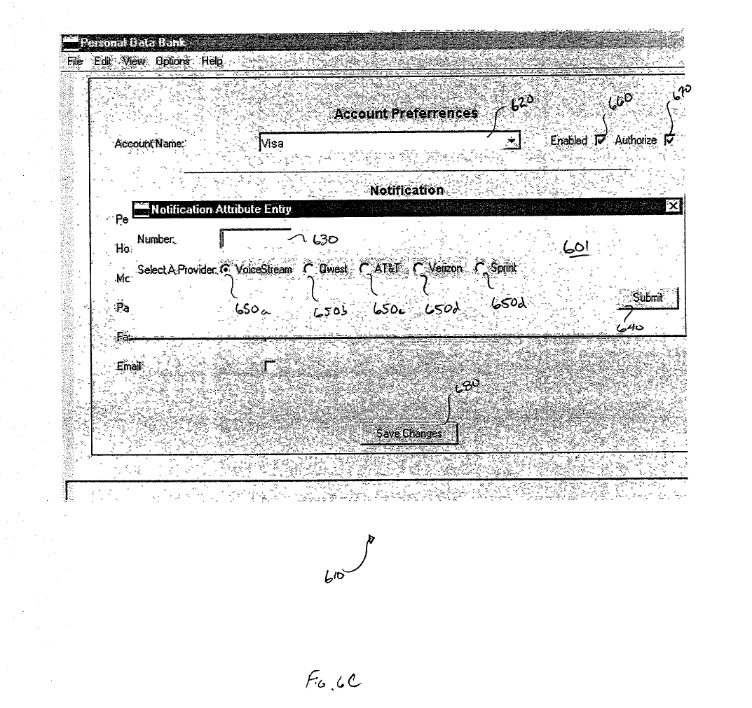

As with the account information, the contact information can be entered via a user interface operating on user device 140. An example of such a user interface 610 tailored for operation on a PC is provided as FIG. 6A. Interface 610 includes an entry field 620 for entering the account for which contact information is to be provided. The entry field can include a pull-down selector for displaying the various accounts associated with the user. Interface 610 also includes selection boxes 690, 691, 692, 693, 694, 695 for selecting the mode by which the user is to be contacted. As illustrated, interface 610 provides for selecting contact via a personal databank maintained on user device 140, by home phone, mobile phone, pager, fax, and email. When a selection box 690, 691, 692, 693, 694, 695 is chosen, an interface is displayed over interface 610 to gather contact information associated with the chosen mode. Examples of such interfaces 600, 601 for gathering the contact information are provided as FIGS. 6B and 6C.

Referring to FIG. 6B, interface 600 tailored for receiving home telephone contact information is illustrated. Interface 600 includes an entry field 630 for entering contact information, and a submission button 640 for indicating that the entry is complete. Once entry field 630 is populated and submission button 640 is pressed, the contact information from the entry field is stored locally on database 141. In addition, the contact information is transferred to central control 120 across communication network 110 and stored in database 121 (blocks 340, 350).

Referring to FIG. 6C, interface 601 is tailored for receiving mobile telephone contact information. In addition to that discussed in relation to interface 600, interface 601 includes the ability to select a particular service provider associated with the telephone number via a series of radial buttons 650. Various embodiments of the present invention provide messaging capability to the user. Such messaging capability is implemented differently depending upon the service provider, thus, as part of the contact information, the service provider is identified. As before, this information is stored locally on database 141 and transferred to central control 120 where it is stored on database 121 (blocks 340, 350).

Interface 610 also includes selection boxes 660 and 670 for enabling and/or authorizing use of the account displayed in entry field 620. Such enabling and authorization is discussed below in relation to notification parameters. Once the desired selections are made, a save changes selection 680 is pressed and the information is stored locally to database 141 and transferred to central control 120 where it is stored on database 121.

Referring again to FIG. 3, notification parameters are provided by a user via user device 140 (block 330). The notification parameters are stored on database 141 and transferred to central control 120 where they are maintained on database 121 (blocks 340, 350). Examples of such notification parameters are illustrated on FIGS. 6 as selection boxes 660 and 670 for enabling and/or authorizing use of the account displayed in entry field 620.

As used herein, a notification parameter can be any rule used to determine whether a user is to be notified of one or more transaction requests. Thus, for example, a notification parameter can provide that all transactions are to be reported to the user for the user's authorization. Alternatively, a notification parameter can provide that only transactions involving a particular account are to be reported. Thus, all transactions occurring in relation to a credit card often loaned to others can be individually monitored, while transactions related to a closely guarded credit card are not individually monitored. Alternatively, all transactions involving a checking account or even a social security account of a user can be individually monitored, while credit card transactions of the same user are not individually monitored. Based on this discussion, one of ordinary skill in the art will recognize many other notification parameters that can be used in accordance with the present invention.

Other examples include notification parameters that provide for notifying a user that a negative piece of information has been added to their credit report, that a credit inquiry has occurred, and the like. Additionally, notification parameters can provide for notifying a user when a social security application, driver's license application, credit card application, bank account application, passport application, visa application, or the like have been filed using the user's identity. Additionally, a notification parameter can be defined to alert a user when a social security check has been cashed or when an insurance claim has been filed.

In some cases, notification parameters can include one or more transaction limits. Such transaction limits can include, but are not limited to, notifying a user of account activity outside of a particular geographic limit, and not notifying a user of account activity occurring within the geographical limit. Such a geographic limit can be defined using zip codes, area codes, physical addresses, and the like. Transaction limits can further include notifying a user when account activity is occurring during a particular time of day, when a particular item or class of items are being purchased in relation to a transaction, when the transaction involves a particular merchant and/or information provider, when a transaction exceeds a certain amount, and the like. Again, based on this description, one of ordinary skill in the art will recognize a myriad of other transaction limits useful in relation to the present invention.

Additionally, notification parameters can be a combination of parameters. Such combinations provide the ability to develop custom notification rules for a given user or group of users. Thus, for example, a notification parameter can provide for notification when an item of jewelry exceeding one-hundred dollars is the subject of a transaction request. Further, notification parameters can involve an intelligent scheme for detecting fraud. Thus, for example, it often occurs that shortly after a credit card is stolen, a small charge is incurred to test the validity of the stolen card, followed by a series of high value charges. Thus, notification parameters can be developed to monitor and detect patterns determined to indicate potential fraud.

It should be recognized that any number of notification parameters, including transaction limits, can be combined to provide any level of notification desired. Further, notification parameters can include rules to be applied to a single transaction request and/or rules to be applied to a group of transaction requests. Thus, as another example, notification parameters operating on a group of transactions can include, among others, notifying a user when a credit card limit is about to be reached, or when a check writing limit.

Further, a user's behavioral patterns can be monitored based on transaction activity and a notification parameters defined to notify a user whenever transaction requests are received that are foreign to the user's behavioral pattern. Thus, for example, if a user consistently purchases gas at one location, notification parameters can be defined to notify the user only when gas is purchased from a location not previously used. In this way, a user is not notified of transactions which are likely to be legitimate, but is notified of transactions that are out of the ordinary. Such an approach can be dynamic and include continued monitoring of the user's transaction behavior to define which transaction requests are likely initiated by the user and which are outside of the user's normal behavior.

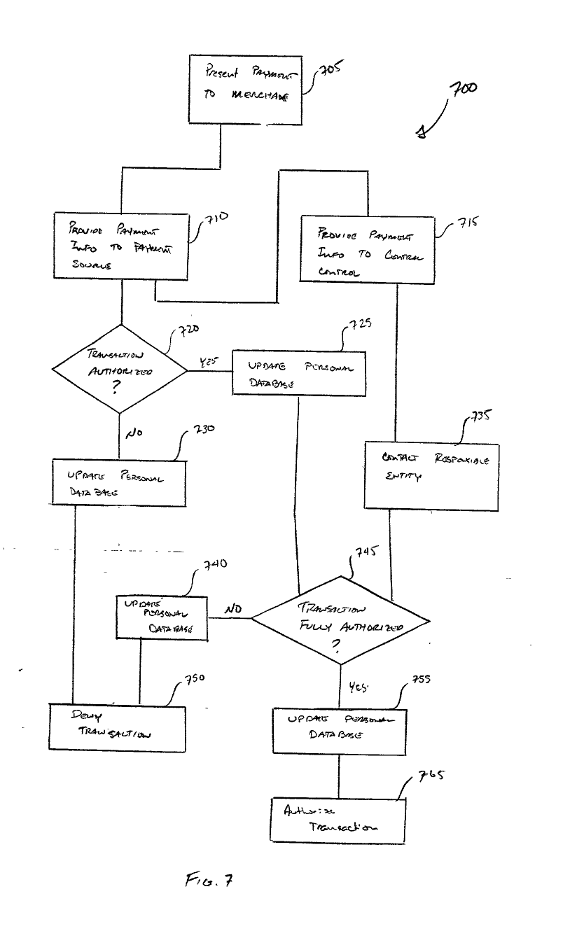

Having uploaded identification information and notification parameters to central control 120, monitoring and/or authorization of transaction requests can be performed. Referring to FIG. 7, a flow diagram 700 illustrates a method of monitoring and authorizing transactions in accordance with embodiments of the present invention. For purposes of illustration, flow diagram 700 is described in relation to a credit card transaction request. However, based on the disclosure herein, one of ordinary skill in the art will recognize various modifications allowing flow diagram 700 to apply to any type of transaction request. More particularly, it will be appreciated that the principles and methods apparent from flow diagram 700 can be applied to transaction requests including, but not limited to, requests to open a bank or brokerage account, requests for a credit report, posting of positive or negative information on a credit report, filing an insurance claim, cashing a check, making a purchase with a check, requesting medical records, applying for social security benefits, applying for a driver's license, applying for a passport or visa, applying for a credit card, or the like.

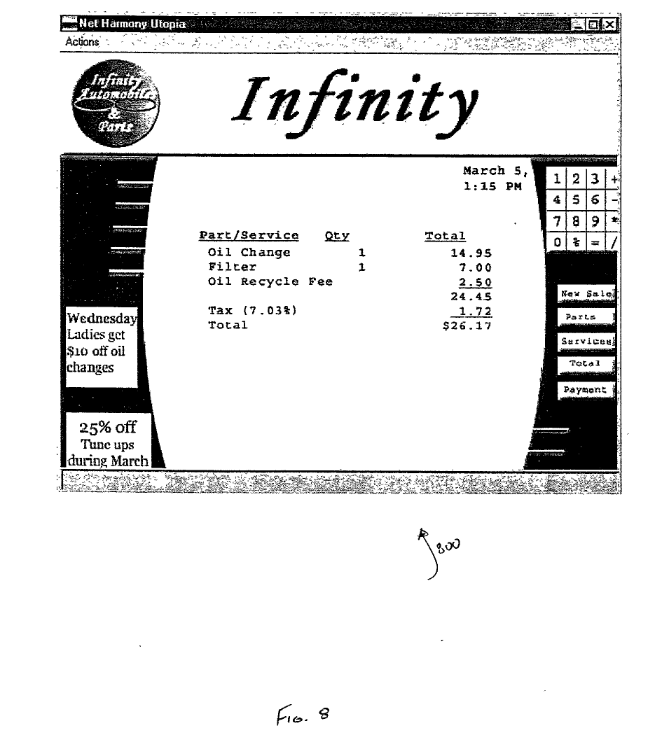

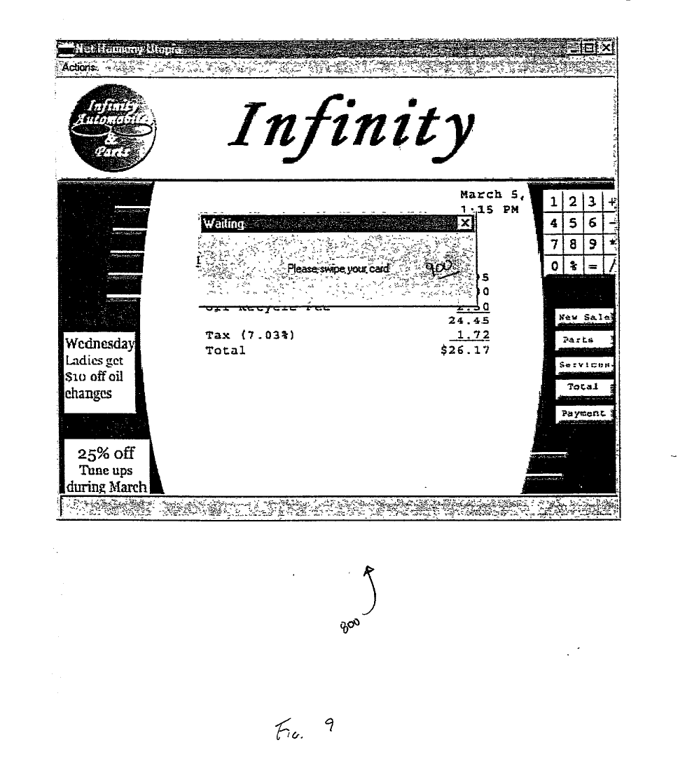

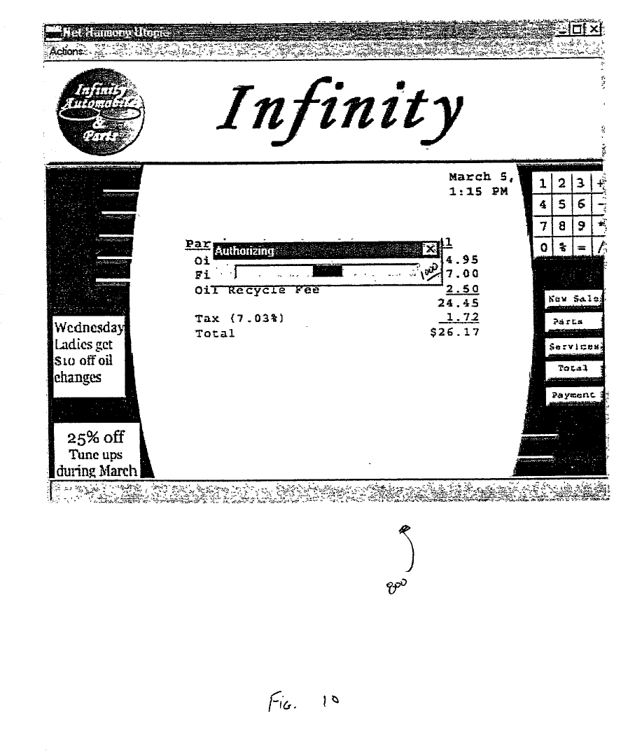

Goods or services to be purchased from a merchant by a user are tallied using POS device 150. FIG. 8 illustrates an example of a transaction screen 800 provided via POS device 150. Then, as illustrated in FIG. 9, a request to enter credit card information 900 is displayed in association with transaction screen 800. Following flow diagram 700 of FIG. 7, a payment or credit card is presented to a merchant to complete the purchase of goods or services (block 705). The credit card can be swiped through a card reader associated with POS device 150. POS device 150 then transmits the payment information including the credit card number, and other authorization information to payment/information system 130 via communication network 110 (block 710). In some embodiments, POS device 150 also transmits the payment information to central control 120 via communication network 110. Alternatively, the payment information is transmitted to central control 120 from payment/information system 130, via communication network 110 (block 715). In systems where central control 120 is integrated with payment/information system 130, such a transfer across communication network 110 is not necessary. While the payment information is being processed by central control 120 and/or payment/information system 130, an authorizing status 1000 is displayed in association with transaction screen 800 as illustrated in FIG. 10.

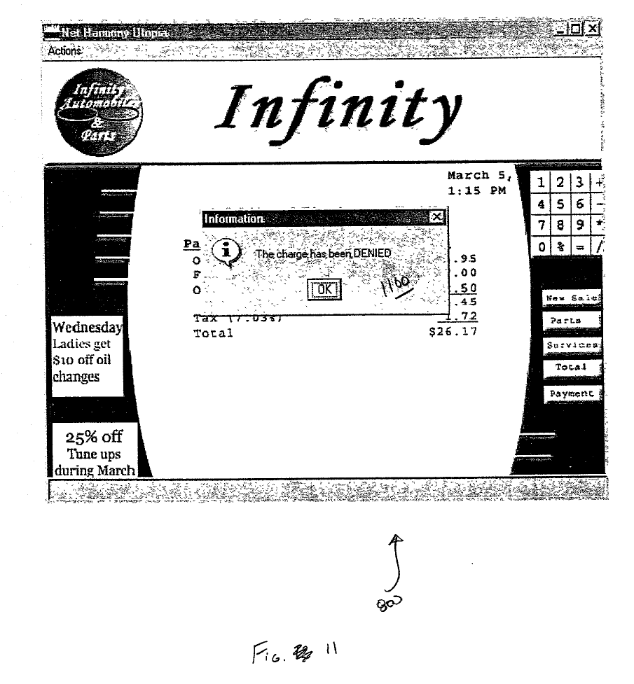

Payment/information system 130 determines if the transaction request is authorized (block 720). Such a determination is made by querying a database associated with payment/information system 130 to determine if, for example, the credit card has been reported stolen, has exceeded a preset spending limit, that the transaction request appears fraudulent, or other conventional determinations made by credit card companies. If it is determined that the transaction request is not to be authorized (block 720), the associated denial is transmitted to central control 120 where it is updated to a user's record maintained on database 121 (block 730). In addition, the transaction request is denied by transmitting a denial message to POS device 150 across communication network 110 (block 750). In response, a denial message 1100 is displayed in association with transaction screen 800 as illustrated in FIG. 11.

Alternatively, if it is determined that the transaction request is to be authorized (block 720), an approval is transmitted to central control 120 where it is updated to a user's record maintained on database 121 (block 725). Final approval of the transaction request is determined by central control 120 based on the notification parameters entered by the user (blocks 735, 745).

More specifically, central control 120 compares the transaction request received in block 715 to identification information entered by the user as described in relation to FIG. 3, blocks 310, 320. This comparison can include matching the credit card number associated with the transaction request with the credit card number previously provided to central control 120. When a match is found, the user associated with the credit card number is notified using the previously provided contact information and according to the previously provided notification parameters (block 735).

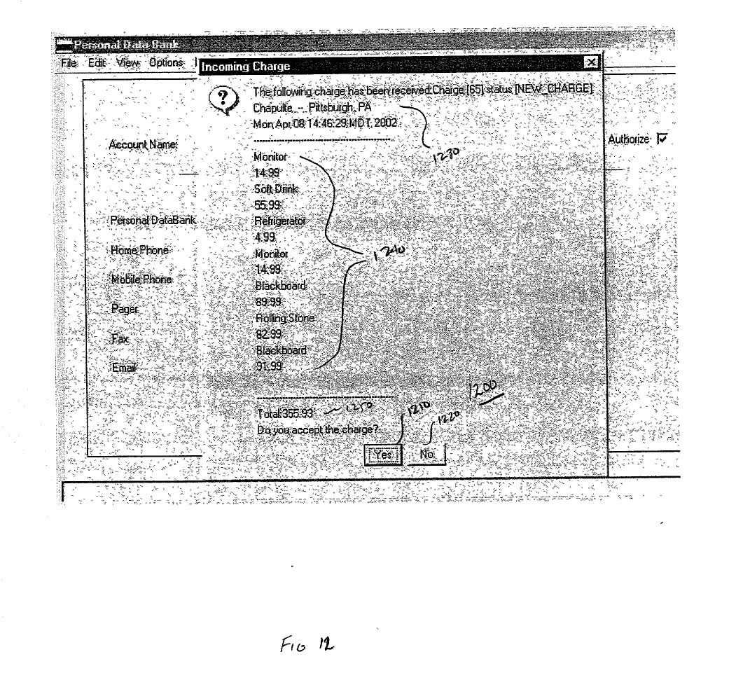

Thus, for example, where the user associated with the credit card number had previously entered a personal databank account as the contact information and requested to authorize all credit card transactions in real-time, central control 120 would initiate contact with the user via the provided personal databank account. Such contact with the user would include a notification of the transaction request and a request to either accept or deny the charges. FIG. 12 illustrates an exemplary interface 1200 used for notifying the user of an ongoing charge. Interface 1200 indicates a merchant 1230 associated with the charge, a subject 1240 of the charge, a total 1250 of the charge, an acceptance selection 1210, and a denial selection 1220. The user is able to review the proposed charge and either accept it or deny it.

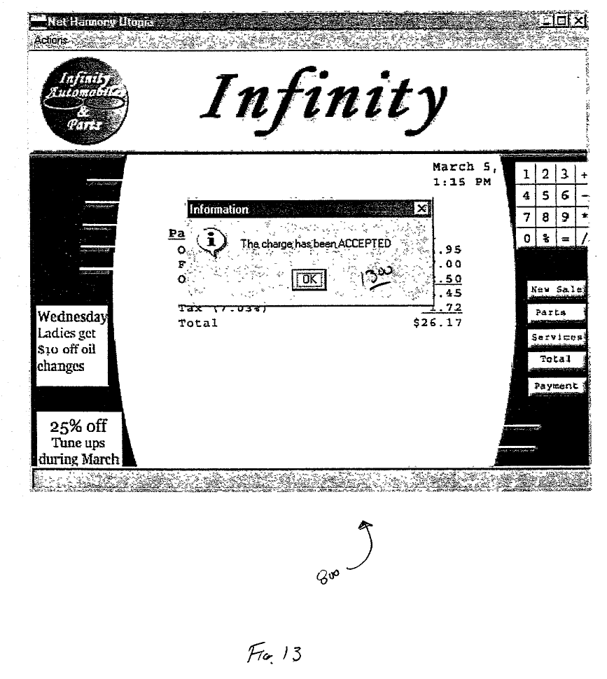

The acceptance or denial is transmitted from user device 140 to central control 120. Based on this acceptance or denial, central control 120 determines if the transaction request is authorized (block 745). With the transaction request having been previously authorized by payment/information system 130, reception of an acceptance from the user fully authorizes the transaction. This full authorization is updated to database 121 (block 755) and transmitted to POS device 150 (block 765). FIG. 13 illustrates an exemplary approval message 1300 displayed in association with transaction screen 800.

Alternatively, if the user denies the transaction request, the transaction is not fully authorized (block 745). This failure to authorize is recorded in database 121 (block 740) and, as previously discussed, a denial message is sent to POS device 150 (block 750). Again, it should be recognized that flow diagram 700 can be modified to track and notified a user of transaction requests other than credit card transactions. In such cases, other accounts entered by the user as account information are monitored. Further, it should be recognized that the other types of contact information and/or notification parameters as previously discussed can be utilized. Thus, for example, a checking account may be monitored and the user contacted by a cellular telephone and asked to approve any check written for an amount exceeding one-thousand dollars. Based on the description provided herein, one of ordinary skill in the art will recognize the various monitoring and/or authorizing approaches made possible by the present invention.

In some embodiments of the present invention, a personal databank is maintained to record activities associated with given users. Thus, for example, when database 121 is updated (blocks 725, 730, 740, 755), this information can be assembled in a personal databank including other information associated with a user. The personal databank can also include all of the identification information and notification parameters as discussed in relation to flow diagram 300. Such a personal databank makes information associated with transaction records readily available to a user through access to a common location.

Further, in some embodiments, the personal databank is replicated on database 141 associated with user device 140. This information can be transmitted to user device 140 as it is received by central control 120. In this way, a user can always have access to the various transaction requests and information associated therewith via access to user device 140, and without needing to access central control 120. Further, where the information is replicated on two databases 121, 141, a readily accessible backup exists.

In particular embodiments, the personal databank is maintained only on database 141, and is not replicated on database 121. In such cases, database 121 maintains sufficient information for central control 120 to identify a user associated with a given transaction and notify the user in accordance with contact information and notification parameters provided by the user. Database 121, however, does not include a record of the individual transaction requests. Thus, updating the database as discussed in relation to blocks 725, 730, 740 and 755 is done by transmitting the information from central control 120 to user device 140, where the information is then maintained on database 141. This approach avoids duplication of data on both databases 121, 141, and provides a user with quick access to a history of transaction requests. Additionally, the approach addresses privacy concerns where a user is worried that personal information may be misappropriated from central control 120 through access to database 121. Additional features of the present invention addressing privacy concerns are discussed below.

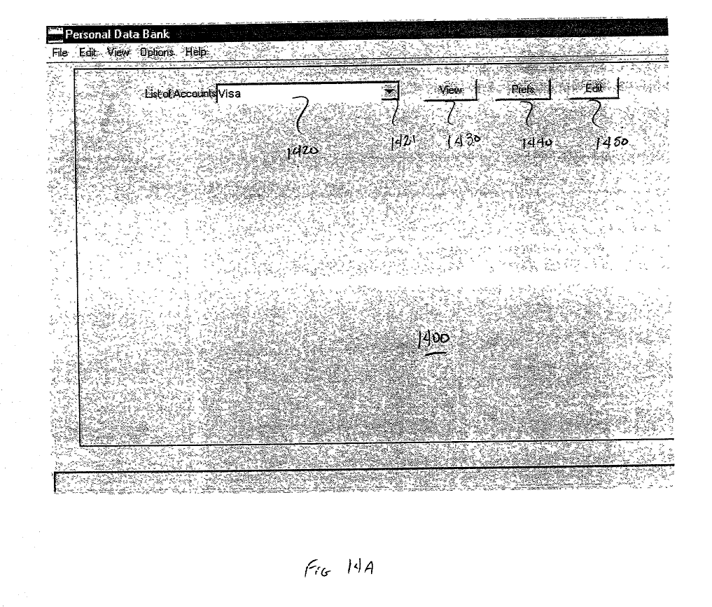

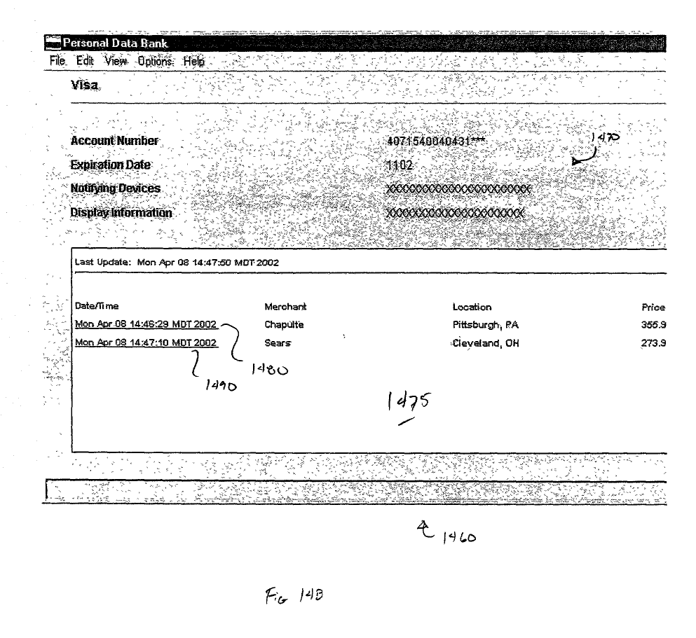

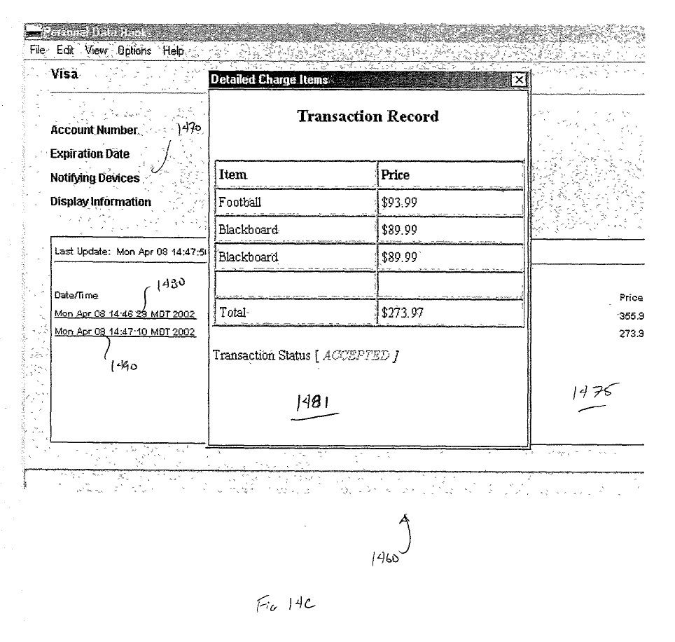

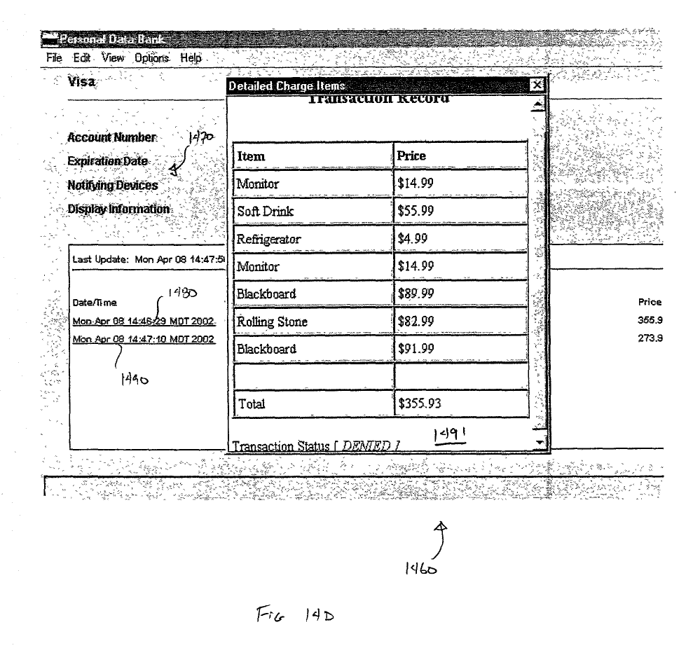

FIGS. 14 illustrate a series of exemplary user interfaces 1400, 1460, 1481, 1491 used for accessing the personal databank. Referring to FIG. 14A, interface 1400 includes an entry field 1420 for selecting an account to be reviewed. Entry field 1420 can include a pull-down selector 1421 for displaying the various accounts associated with the user. After selecting the account to be reviewed, a user can choose a view selection 1430, a preferences selection 1440, or an edit selection 1450. By choosing preferences selection 1440, a user is presented with other interfaces whereby the user can review and modify preferences associated with the maintenance and access to information within the personal databank. By choosing edit selection 1450, a user is presented with other interfaces whereby the user can review and modify identification information including contact information and account information, as well as notification parameters associated with the account. Such interfaces can be similar to those illustrated in FIGS. 6.

By choosing view selection 1430, a user is presented with other interfaces whereby the user can review transaction requests maintained in the personal databank, as well as, the status of the transaction requests. Interface 1460 of FIG. 14B is exemplary of an interface presented in response to choosing view selection 1430. Interface 1460 includes a field 1470 for displaying relevant information about the selected account. A field 1475 lists various transaction requests 1480, 1490 associated with the selected account. Each of the individual transaction requests 1480, 1490 can be individually selected and viewed in greater detail.

By choosing transaction request 1480, a detailed view 1481 of the transaction request as illustrated in FIG. 14C is presented to the user. Similarly, by choosing transaction request 1490, a detailed view 1491 of the transaction request as illustrated in FIG. 14D is presented to the user.

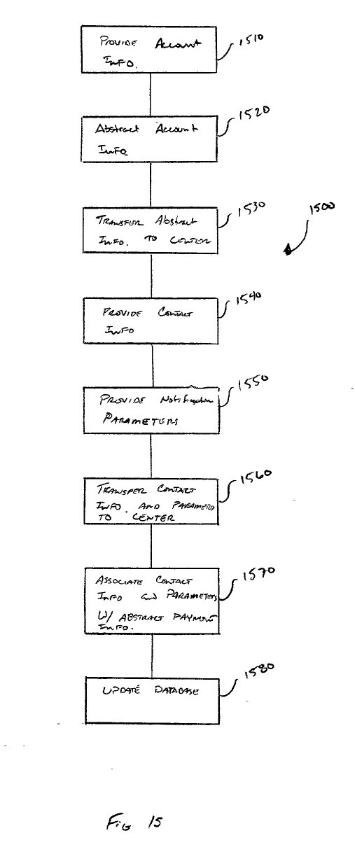

Referring to FIG. 15, a flow diagram 1500 illustrates another method of providing account, contact and parameter information including account information abstraction in accordance with other embodiments of the present invention. Following flow diagram 1500, account information is provided by the user via user device 140 to central control 120 (block 1510). The account information is then abstracted (block 1520).

As used herein, abstracting information is a process whereby information is converted to a form that conceals the underlying information, but retains the information in a useable format. Thus, for example, a user's credit card account number can be abstracted such that the underlying account number is no longer accessible, but the abstracted account number can be matched to the same account number having been converted using the same abstraction process.

In some embodiments of the present invention, abstracting information is accomplished using a one-way hash function. Such one-way hash functions are also known as a message digest, fingerprint, or compression functions. The function is a mathematical function which takes a variable-length input string and converts it into a fixed-length binary sequence. It is designed such a way that the process either cannot be reversed or is very difficult to reverse. Thus, it is difficult to ascertain the underlying information that hashes to provide the result of the one-way hash function. Further, the one-way hash function is designed such that two different pieces of information either never produce the same result or are highly unlikely to produce the same result.

Some hash functions useful in relation to the present invention provide a drastically different output where even a slight change in the input information exists. In such cases, even if a single bit of the input information is modified, at least half of the bits in resulting output can be changed. This is often referred to as the avalanche effect. Since it is computationally infeasible to produce information that would hash to a given value or find two information pieces that hash to the same value, abstraction of information using a hash function can serve as a cryptographic equivalent of the information. Thus, the resulting output can be used for identification and/or matching purposes, without allowing access to the underlying information. In accordance with the present invention, one of ordinary skill in the art will recognize a number of possibilities, including various hash functions, for providing useable information, while concealing the underlying information.

The abstracted account information is transferred to central control 120 via communication network 110 (block 1530). In addition, contact information (block 1540) and notification parameters (1550) associated with the account are provided by the user and transferred to central control 120 via communication network 110 (block 1560). The contact information and notification parameters are associated with the abstracted account information (block 1570). In some embodiments, associating the information includes created a record for the user that includes contact, account, and notification parameter information for one or more accounts provided by the user. Such a record is stored on database 121 (block 1580).

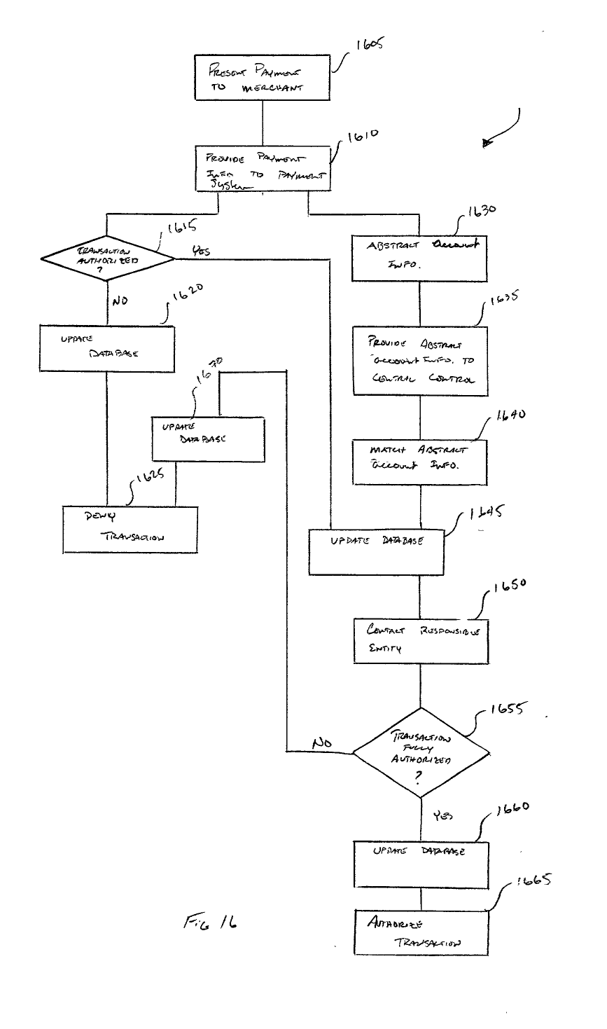

Having uploaded identification information and notification parameters to central control 120, monitoring and/or authorization of transaction requests can be performed. Referring to FIG. 16, a flow diagram 1600 illustrates a method of monitoring and authorizing transactions in accordance with embodiments of the present invention. For illustration purposes, flow diagram 1600 is described in relation to a transaction request where a check is presented. As with the description of flow diagram 700, one of ordinary skill in the art will recognize various modifications allowing flow diagram 1600 to apply to any type of transaction request.

Following flow diagram 1600, a check is presented to a merchant to complete the purchase of goods or services (block 1605). The check information including routing and account numbers are entered via POS device 150. The check information is then transferred to payment/information system 130 via communication network 110 (block 1610).

Payment/information system 130 determines if the transaction is authorized (block 1615). Such a determination can include, but is not limited to, determining if an account associated with the check is open and if sufficient funds exist to cover the check. If payment/information system 130 does not approve payment for the check, a denial is transmitted to POS device 150 (block 1625), and also to central control 120 where it is updated to a user's record maintained on database 121 (block 1620).

Alternatively, if payment/information system 130 approves payment for the check, an approval is transmitted to central control 120 where it is updated to a user's record maintained on database 121 (block 1645). In addition, the account information is abstracted using a function similar to that used when the user entered the account information (block 1630). The abstracted account information is then transmitted to central control 120 via communication network 110 (block 1635). Thus, central control never actually has the account information. Rather, central control 120 only has the abstracted account information provided both from the user as discussed in relation to flow diagram 1500, and from payment/information system 130. The abstracted account information received from payment/information system 130 is compared with abstracted account information provided by the user and maintained on database 121 (block 1640). A match in the abstracted account information reveals the user associated with the account, along with contact information and notification parameters dictating when and how the user is to be contacted. Then, according to the contact information and the notification parameters, the user is contacted (block 1650).

In some instances, the notification parameters indicate that the transaction request is a type that is to be automatically authorized. In such situations, contacting the user is not necessary. Similarly, where the notification parameters indicate that the transaction request is a type that is never to be authorized, contacting the user is also not necessary. In situations where the user is to be contacted, a request for approval is transmitted to user device 140 across communication network 110. In one particular embodiment, the user device includes a cell phone by which the user is contacted. Thus, a user standing at the merchant's location is contacted via the cell phone and queried whether to approve the transaction request. If the user indicates an approval, the transaction is fully authorized (block 1655). The authorized transaction request is updated in database 121 (block 1660), and an approval is transmitted to POS device 150 via communication network 110 (block 1665). Alternatively, if the user indicates a denial, the transaction is not fully authorized (block 1655). The failed transaction request is updated in database 121 (block 1670), and a denial is transmitted to POS device 150 via communication network 110 (block 1665).

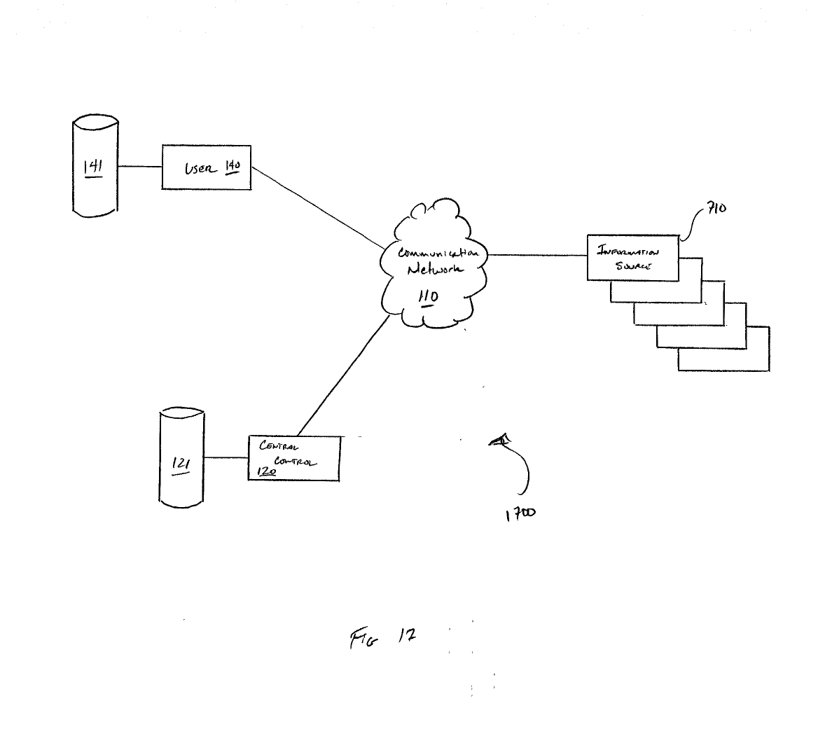

FIG. 17 illustrates yet another embodiment according to the present invention of a system 1700 for monitoring personal information. System 1700 includes user device 140, central control 120, and an information source 710 in communication via communication network 110. Information source 710 can be any source of information, such as, a credit reporting bureau, an insurance company, bank account, a driver's license bureau, the social security administration, a credit card company, and the like. System 1700 is particularly suited for monitoring information being reported or accessed regarding a particular user from any of a number of information sources 710. As such, system 1700 is particularly useful, among other things, for monitoring and identifying a potential incidence of identity theft.

As used herein, identity theft is any activity where an individual or entity wrongfully takes and uses another's personal information in a way that involves fraud or deception. In some cases, such identity theft involves representations using another's personal information as a way to get financial gain. As one example, a person may open a brokerage account using the identity of another, trade on the account in such a way that capital gains are incurred, withdrawal the money from the account, and disappear leaving the person identified on the account liable for the tax implications of the account activity. Of course, the example provided is merely exemplary and many other forms of identity theft are known.

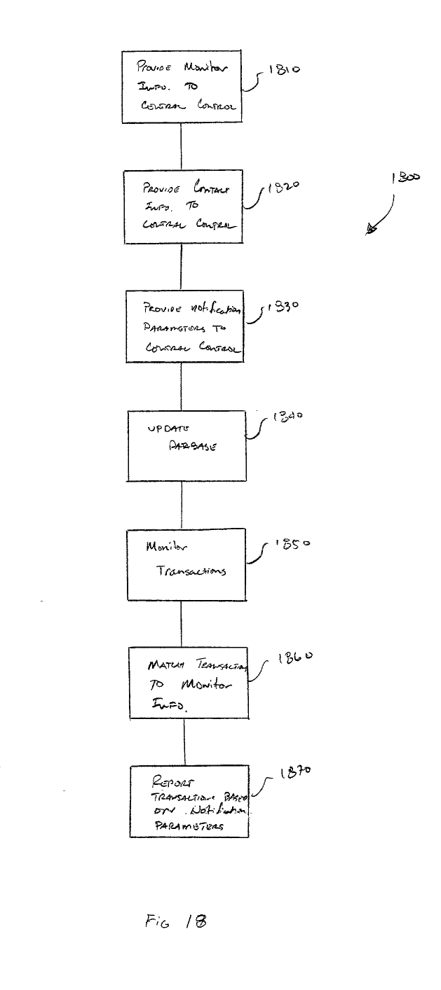

FIG. 18 is a flow diagram 1800 illustrating a method for initiating and monitoring personal information using central control 120. Following flow diagram 1800, a user enters various information to be monitored via user device 140 and transmits the information to central control 120 (block 1810). Such information to be monitored can include, but is not limited to, driver's license numbers, insurance account numbers, social security numbers, bank account numbers, credit card numbers, and the like.

In addition, the user provides contact information (block 1820) and notification parameters (block 1830) to central control 120. All of the information from the user is maintained in database 121. Central control 120 then monitors transactions in any way associated with the information provided by the user (block 1850).

Monitoring the transactions can be either proactive, passive, or a combination thereof. For example, central control 120 can proactively monitor transactions by requesting information from one or more information sources 710. Alternatively, central control 120 can passively monitor by waiting for one or more information sources 710 to provide transaction information to central control 120. Either way, central control 120 compares the available transaction information with an information profile of the user. When the transaction information matches information provided by the user (block 1860), the user is notified of the transaction information based on the contact information and the notification parameters (block 1870). In some cases, for example, a user is notified whenever a certain level of activity is detected. Thus, rather than receive notification of each and every transaction, a user may only be notified when a certain activity threshold is exceeded. If the user is then interested, the user can access the personal databank associated with the user to investigate the transaction record.

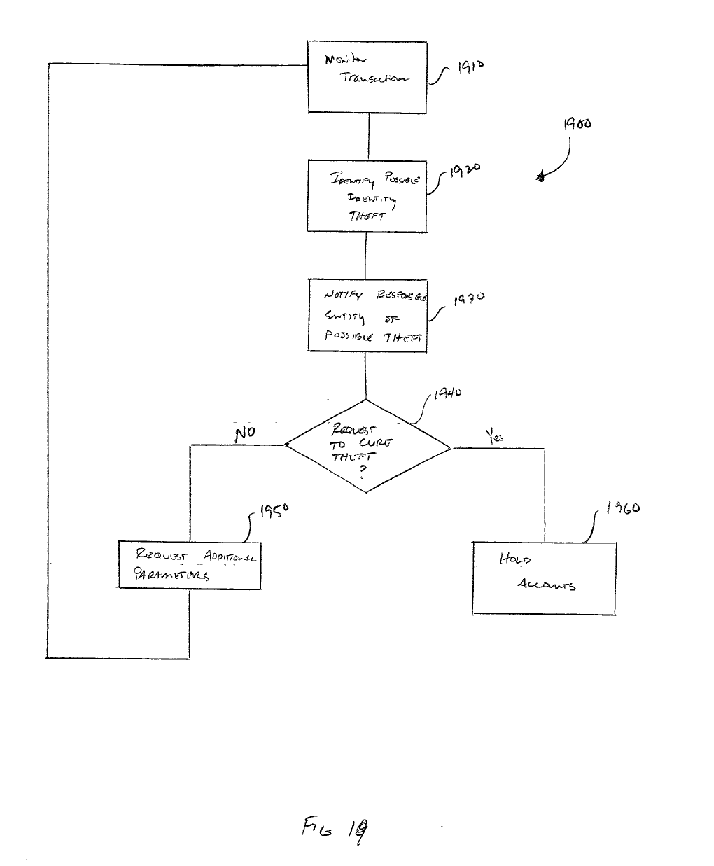

Some embodiments of the present invention provide for curing the potential identity theft. One such embodiment is illustrated as flow diagram 1900 of FIG. 19. Following flow diagram 1900, central control 120 monitors the available transactions (block 1910). Based on this monitoring, a potential identity theft may be detected (block 1920). Various methods of defining a potential identity theft can be used in accordance with the present invention. For example, a request for more than one credit card account within a limited period may be sufficiently suspicious to indicate a potential identity theft. One of ordinary skill in the art will recognize other such patterns that can be flagged as suspicious. Further, such patterns can be defined by the user in the form of notification parameters.

When a potential identity theft is detected, the user related to the potential identity theft is contacted using the contact information (block 1930). The user is asked if they desire for central control 120 to implement measures to cure and/or limit the potential identity theft (block 1940). If the user indicates that a cure should be implemented, central control 120 contacts entities involved with the suspicious behavior and requests that a hold be placed on any further processing of the transaction request. Additionally, other accounts, such as credit cards and bank accounts can be disabled while the investigation proceeds. For example, a notification parameter for a credit card account within the personal databank can be set to deny all transactions. Once the investigation is complete, the credit card can be re-enabled by returning the notification parameter to its previous state. Based on this discussion, one of ordinary skill in the art will recognize many other processes that can be effectuated by central control 120 to stop or limit any potential identity theft.

Alternatively, where the user is merely irritated by the notification of potential identity theft, central control 120 can request that the user provide less aggressive notification parameters (block 1950). Any new notification parameters may then be used for continued monitoring (block 1910) as previously discussed.

The invention has now been described in detail for purposes of clarity and understanding. However, it will be appreciated that certain changes and modifications may be practiced within the scope of the appended claims. For example, central control 120 can monitor transactions occurring in relation to any number or type of payment/information systems 130 and/or information sources 710. Accordingly, it should be recognized that many other systems, functions, methods, and combinations thereof are possible in accordance with the present invention. Thus, although the invention is described with reference to specific embodiments and figures thereof, the embodiments and figures are merely illustrative, and not limiting of the invention. Rather, the scope of the invention is to be determined solely by the appended claims.

What is claimed is:

1. A method for evaluating transactions associated with one or more transaction systems, the method comprising:
providing a central control;
receiving identification information associated with a user at the central control, wherein the identification information includes contact information related to the user;
receiving a transaction request from a third party;
matching the transaction request to the user; and
alerting the user of the transaction request.

2. The method of claim 1, wherein the identification information further comprises account information associated with the user, and wherein the transaction request comprises the account information associated with the user.

3. The method of claim 2, the method further comprising:
receiving at least one notification parameter from the user at the central control, wherein the notification parameter at least in part controls the alerting the user of the transaction request.

4. The method of claim 3, wherein the notification parameter indicates a transaction limit, and wherein alerting the user of the transaction request is done at least in part based upon the transaction request satisfying the transaction limit.

5. The method of claim 2, wherein the account information is received from the user in a format that conceals the account, and is matchable to the user.

6. The method of claim 5, wherein the account information is further received from the third party in a format that conceals the account, and is matchable to the user.

7. The method of claim 2, wherein the account information is a social security identification number.

8. The method of claim 1, wherein alerting the user of the transaction request comprises providing an indication of a potential identity theft.

9. The method of claim 8, the method further comprising:
receiving a request from the user to limit the potential identity theft; and
providing a request to one or more entities associated with the user, wherein the request indicates that any further access to the entity in the name of the user should be at least limited.

10. The method of claim 1, wherein providing the transaction request to the user comprises communicating the transaction request across a communication network to a device identified by the user.

11. The method of claim 10, wherein the alerting the user of the transaction request comprises providing an acceptance request to the user, the method further comprising:
receiving a response to the acceptance request; and
based on the response, providing an authorization to the third party.

12. An interactive monitoring system, the system comprising:
a central control coupled to a communication network, wherein the central control comprises a memory and a processor; and
wherein the memory comprises instructions executable by the processor to:
receive contact information and account information related to a user;
receive a transaction request from a third party, wherein the transaction request comprises the account information;
match the transaction request to the user;
access the contact information associated with the user; and
alert the user of the transaction request according to the contact information.

13. The system of claim 12, wherein the memory further comprises instructions executable by the processor to:
receive at least one notification parameter associated from the user; and
access the notification parameter, wherein alerting the user of the transaction request is based at least in part on the notification parameter.

14. The system of claim 13, wherein the notification parameter comprises a transaction limit, and wherein the instructions to alert the user of the transaction request include instructions to alert the user where the transaction request exceeds the transaction limit.

15. The system of claim 12, wherein the account information is received in a format that conceals the account, and is matchable to the user, and wherein matching the transaction request to the user comprises matching the account information associated with the user to the account information received from the third party, while the account information remains concealed.

16. The system of claim 12, wherein the account information comprises a social security number of the user.

17. The system of claim 12, wherein the transaction request is a request to authorize use of a credit card.

18. The system of claim 17, wherein the central control is associated with a credit card processing system.

19. The system of claim 12, wherein the instructions to alert the user of the transaction request comprise instructions to identify a potential identity theft and to alert to the user of the potential identity theft.

20. The system of claim 12, wherein providing the transaction request to the user comprises providing an acceptance request to the user, and wherein the memory further comprises instructions executable by the processor to:
receive a response from the user to the acceptance request; and
based on the response, provide an authorization to the third party.

21. A method for authenticating a user in a financial transaction, the method comprising:
receiving identification information associated with a user at a central control, wherein the identification information includes contact information and account information related to the user;
receiving a transaction request from a third party, wherein the transaction request comprises the account information related to the user;
matching the transaction request to the user;
providing an acceptance request to the user;
receiving a response to the acceptance request; and
based at least in part on the response, providing an authorization to the third party.

22. The method of claim 21, wherein the response is predefined by the user, and maintained on the central control.

23. A method for detecting potential identity theft, the method comprising:
receiving at least contact information and a social security identification number related to a user at a central control;
receiving a transaction request from a third party, wherein the transaction request comprises the social security number related to the user;
matching the transaction request to the user; and
based at least in part on the transaction request, alerting the user of a potential identity theft.
